(19) United States
(12) Patent Application Publication
(10) Pub. No.: US 2025/0155670 A1
(43) Pub. Date: May 15, 2025

(54) DIOPTER ADJUSTMENT DEVICE AND VIRTUAL REALITY APPARATUS

(71) Applicant: AAC ACOUSTIC TECHNOLOGIES (SHENZHEN) CO., LTD., Shenzhen (CN)

(72) Inventors: Qinghua Lin, Shenzhen (CN); Songtao Li, Shenzhen (CN); Hongyan Tao, Shenzhen (CN); Junhao Yuan, Shenzhen (CN)

(21) Appl. No.: 18/637,379

(22) Filed: Apr. 16, 2024

Related U.S. Application Data
(63) Continuation of application No. PCT/CN2023/131240, filed on Nov. 13, 2023.

(51) Int. Cl. G02B 7/10

(52) U.S. Cl. CPC G02B 7/10

(57) ABSTRACT

A diopter adjustment device and a virtual reality (VR) apparatus are provided. The diopter adjustment device includes a lens mounting part, a guide adjustment part, and a driving part. The lens mounting part is configured to mount a lens module. The guide adjustment part is connected to the lens mounting part, the guide adjustment part moves along a preset path to drive the lens mounting part to move along a first direction, and the driving part is configured to drive the guide adjustment part to move along the preset path. Compared with the prior art, the diopter adjustment device includes the lens mounting part, the guide adjustment part, and the driving part, the driving part drives the guide adjustment part to move along the preset path, so as to drive the lens mounting part to reciprocate to automatically adjust the diopters.

### TECHNICAL FIELD

The present disclosure relates to the field of virtual reality technology, and in particular to a diopter adjustment device and a virtual reality (VR) apparatus.

### BACKGROUND

VR is an abbreviation of virtual reality, when using a VR apparatus, a position of an optical lens usually needs to adjust for accommodating users with different visual acuity, so that the users with different visual acuity may have better user experience. However, when a current VR apparatus is in use, a diopter thereof is generally manually adjusted, specifically, a VR optical module is first adjusted to an appropriate diopter, and image definition is next confirmed after wearing the VR optical module in place, if the image definition is not clear enough, the users need to take off the VR apparatus to readjust the diopter or pull a push button to adjust the diopter, which is not convenient for the users to quickly adjust the diopter to a reasonable diopter, thereby affecting user experience.

### SUMMARY

The present disclosure aims to provide a diopter adjustment device and a virtual reality (VR) apparatus to solve technical problems in the prior art, the diopter adjustment device is capable of automatically adjusting diopters.

In a first aspect, the present disclosure provides the diopter adjustment device, including a lens mounting part, a guide adjustment part, and a driving part. The lens mounting part is configured to mount a lens module. The guide adjustment part is connected to the lens mounting part, the guide adjustment part moves along a preset path to drive the lens mounting part to move along a first direction, and the driving part is configured to drive the guide adjustment part to move along the preset path.

As an improvement, the driving part includes a driving motor, a worm, a transmission gear set, and a ring gear. An output shaft of the driving motor is coupled to the worm to drive the worm to rotate. The ring gear is disposed on the guide adjustment part, and the transmission gear set is respectively engaged with the worm and the gear ring.

As an improvement, the transmission gear set includes a first gear and a second gear, the first gear and the second gear are coaxially disposed, a diameter of the first gear is different from a diameter of the second gear, the first gear is engaged with the worm, and the second gear is engaged with the gear ring.

As an improvement, the guide adjustment part defines an accommodating cavity, at least one first guide groove is defined on an inner surface of the accommodating cavity, a preset included angle is formed between an extending direction of the at least one first guide groove and the first direction. The lens mounting part is at least partially accommodated in the accommodating cavity, at least one first guide protrusion is disposed on an outer surface of the lens mounting part, and the least one first guide protrusion is in clearance fit with the first guide groove.

As an improvement, a plurality of first guide protrusions are disposed on the outer surface of the lens mounting part, a plurality of first guide grooves are defined on the inner wall of the accommodating cavity, and the plurality of the first guide protrusions are disposed in one-to-one correspondence with the plurality of the first guide grooves.

As an improvement, the at least one first guide groove spirally extends.

As an improvement, both the lens mounting part and the guide adjustment part are cylindrical structures, the guide adjustment part coaxially covers on a periphery of the lens mounting part.

As an improvement, the diopter adjustment device includes a limiting part, the limiting part is configured to limit further movement of the guide adjustment part when the guide adjustment part moves from a starting end of the preset path to a tail end of the preset path.

As an improvement, the limiting part includes at least one limiting protrusion, a first travel switch, and a second travel switch. The at least one limiting protrusion is disposed on the guide adjustment part. Both the first travel switch and the second travel switch are electrically connected to the driving part. The first travel switch is disposed at the tail end of the preset path, when the at least one limiting protrusion moves to the tail end of the preset path, the at least one limiting protrusion triggers the first travel switch. The second travel switch is disposed at the starting end of the preset path, when the at least one limiting protrusion moves to the starting end of the preset path, the at least one limiting protrusion triggers the second travel switch.

In a second aspect, the present disclosure provides the VR apparatus.

Compared with the prior art, the diopter adjustment device of the present disclosure includes the lens mounting part, the guide adjustment part, and the driving part, the driving part drives the guide adjustment part to move along the preset path, so as to drive the lens mounting part to reciprocate to automatically adjust the diopters.

### BRIEF DESCRIPTION OF DRAWINGS

FIG. 1 is a structural schematic diagram of a perspective view of a diopter adjustment device according to one embodiment of the present disclosure.

FIG. 2 is a structural schematic diagram of another perspective view of the diopter adjustment device according to one embodiment of the present disclosure.

FIG. 3 is a structural schematic diagram of a front view of the diopter adjustment device according to one embodiment of the present disclosure.

FIG. 4 is a structural schematic diagram of a rear view of the diopter adjustment device according to one embodiment of the present disclosure.

FIG. 5 is a cross-sectional schematic diagram taken along line A-A shown in FIG. 4.

FIG. 6 is a structural schematic diagram of a perspective view of the diopter adjustment device removing a pressing plate.

FIG. 7 is a structural schematic diagram of another perspective view of the diopter adjustment device removing the pressing plate.

FIG. 8 is a schematic diagram of a perspective view of a guide adjustment part of the diopter adjustment device according to one embodiment of the present disclosure.

FIG. 9 is a schematic diagram of a top view of the guide adjustment part of the diopter adjustment device according to one embodiment of the present disclosure.

FIG. 10 is a schematic diagram of a perspective view of a lens mounting part of the diopter adjustment device according to one embodiment of the present disclosure.

FIG. 11 is a schematic diagram of a perspective view of a supporting base of the diopter adjustment device according to one embodiment of the present disclosure.

Reference numerals in the drawings: 10. lens mounting part; 11. lens module; 12. first guide protrusion; 13. second guide protrusion; 20. guide adjustment part; 21. accommodating cavity; 22. first guide groove; 23. ring gear; 24. convex ring; 25. limiting protrusion; 30. driving part; 31. driving motor; 32. worm; 33. transmission gear set; 331. first gear; 332. second gear; 40. limiting part; 41. first travel switch; 42. second travel switch; 50. bottom plate; 60. supporting base; 61. convex cylinder; 62. second guide groove; 70. pressing plate; 80. motor mounting plate; D1. first direction.

### DETAILED DESCRIPTION OF EMBODIMENTS

Embodiments described below with reference to accompanying drawings are exemplary and are only used to explain the present disclosure, but are not to be construed as limiting the present disclosure.

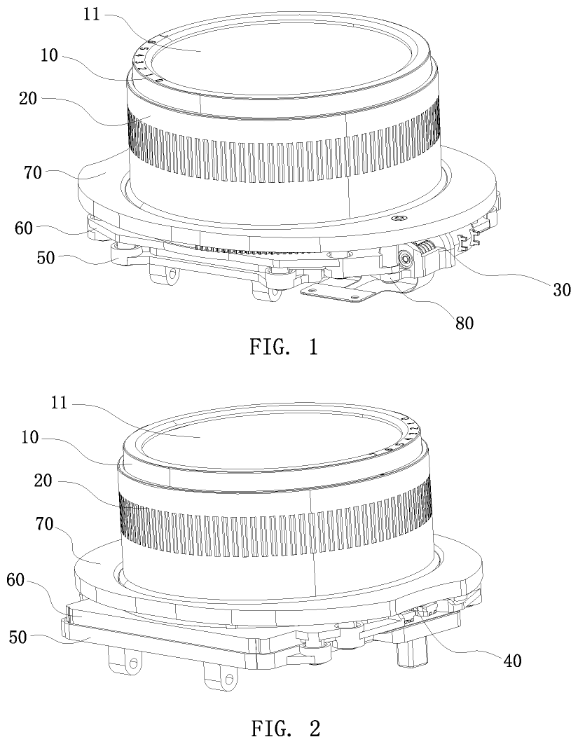

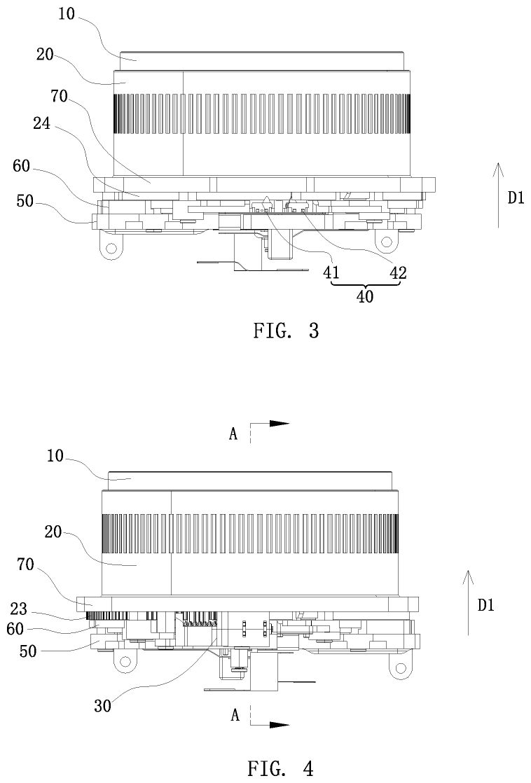

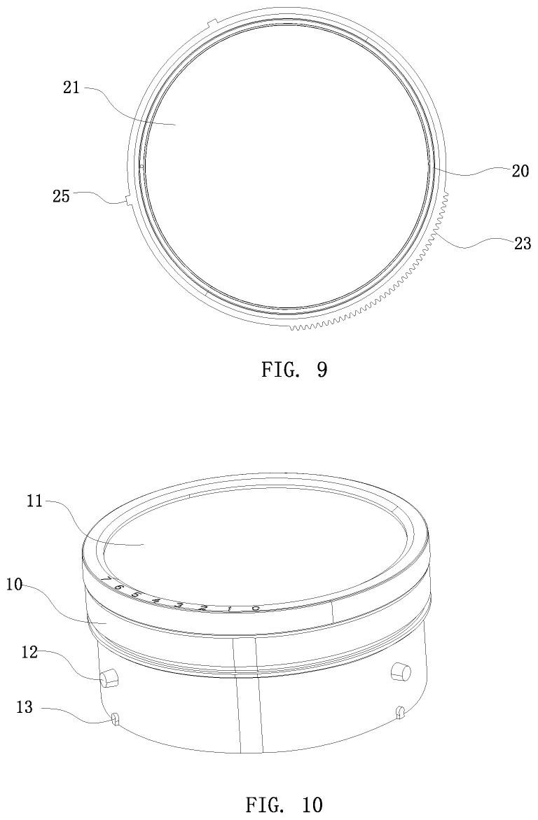

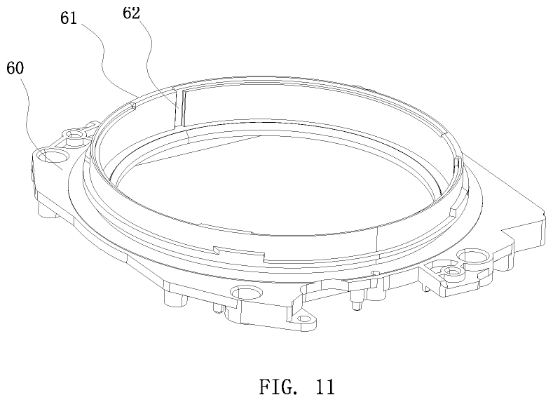

As shown in FIGS. 1-11, the embodiments of the present disclosure provide a diopter adjustment device, including a lens mounting part 10, a guide adjustment part 20, and a driving part 30. The lens mounting part 10 is configured to mount a lens module 11, a structure of the lens module 11 refers to lens module structures in the prior art, which is not limited herein, for example, the lens module 11 may include but is not limited to at least two convex lenses disposed at intervals. After a user wears a virtual reality (VR) apparatus, a visual focus of the user falls on a viewfinder eyepiece (not shown in the drawings) of the VR apparatus through a lens. By adjusting a distance between the lens module 11 and the viewfinder eyepiece of the VR apparatus, that is, by changing diopters, users with different visual acuity may have a clear visual effect.

The guide adjustment part 20 is connected to the lens mounting part 10 to guide the lens mounting part 10 to move in order, the guide adjustment part 20 moves along a preset path to drive the lens mounting part 10 to move along a first direction D1, the first direction D1 is a direction in which the lens module 11 faces the viewfinder eyepiece of the VR apparatus, when the lens mounting part 10 reciprocates in the first direction D1, changes in the diopters correspond to changes in the distance between the lens module 11 and the viewfinder eyepiece of the VR apparatus.

The driving part 30 is configured to drive the guide adjustment part 20 to move along the preset path, so as to automatically adjust the diopters, compared with manual adjustment, the diopters of the lens module 11 are more conveniently adjusted without repeatedly wearing the VR device, thereby improving user experience and being more concise and convenient to operate.

In the embodiments of the present disclosure, the preset path of the guide adjustment part 20 is a rotation motion of the guide adjustment part 20 taking an axis thereof as a center line, and compared with linear movement, an internal space of the VR apparatus is saved, so that the VR apparatus is lighter and thinner. For driving a forward rotation or a reverse rotation of the guide adjustment part 20, in one embodiment, referring to FIG. 6, the driving part 30 includes a driving motor 31, a worm 32, a transmission gear set 33, and a ring gear 23. An output shaft of the driving motor 31 is coupled to the worm 32 to drive the worm 32 to rotate. The ring gear 23 is disposed on the guide adjustment part 20, and the transmission gear set 33 is respectively engaged with the worm 32 and the gear ring 23. The transmission gear set 33 is configured to transmit a driving force to the guide adjustment part 20 in a variable speed manner; when the driving motor 31 rotates in a forward direction, and torque is transmitted to the guide adjustment part 20 through the worm 32, the transmission gear set 33, and the gear ring 23, thereby achieving the forward rotation of the guide adjustment part 20; when the driving motor 31 rotates in a reverse direction, the torque is transmitted to the guide adjustment part 20 through the worm 32, the transmission gear set 33, and the gear ring 23, thereby achieving the reverse rotation of the guide adjustment part 20.

As an improvement, referring to FIG. 6, the transmission gear set 33 is a duplicate gear, including a first gear 331 and a second gear 332, the first gear 331 and the second gear 332 are coaxially disposed, the first gear 331 and the second gear 332 have the same modulus, but a diameter of the first gear 331 is different from a diameter of the second gear 332, the diameter of the first gear 331 is larger than the diameter of the second gear 332, the first gear 331 is engaged with the worm 32, and the second gear 332 is engaged with the gear ring 23, thereby changing a rotating speed of the output shaft of the driving motor 31, so that adjustment precision of the lens module 11 is avoided from being reduced due to too fast rotating speed of the guide adjustment part 20.

Referring to FIG. 8, the guide adjustment part 20 defines an accommodating cavity 21, an inner contour surface of the accommodating cavity 21 is matched with an outer contour surface of the lens mounting part 10, and at least one end surface of the accommodating cavity 21 defines an opening, at least one first guide groove 22 is defined on an inner surface of the accommodating cavity 21, a preset included angle is formed between an extending direction of the at least one first guide groove 22 and the first direction D1. In one embodiment, the at least one first guide groove 22 is a spiral groove, and the at least one first guide groove 22 spirally extends upward along the first direction D1.

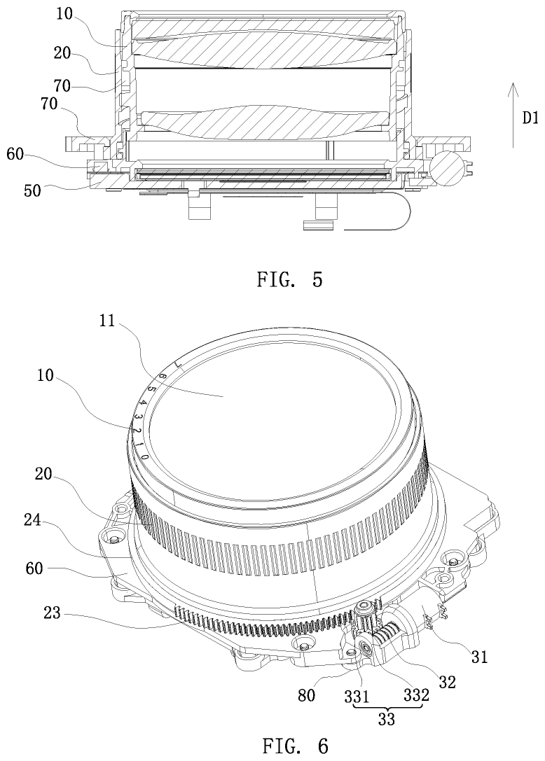

Referring to FIGS. 5, 8, and 10, the lens mounting part 10 is at least partially accommodated in the accommodating cavity 21 through the opening, and the lens mounting part 10 is in clearance fit with the accommodating cavity 21, at least one first guide protrusion 12 is disposed on an outer surface of the lens mounting part 10, and the least one first guide protrusion 12 is in clearance fit with the first guide groove 10. Since the at least one first guide groove 22 is inclined to a moving direction of the lens mounting part 10; when the guide adjustment part 20 takes the axis thereof as the center line and rotates around the axis thereof in a forward direction, a bottom wall surface of the at least one first guide groove 22 abuts against the at least one first guide protrusion 12 to give a force facing the viewfinder eyepiece of the VR apparatus to the at least one first guide protrusion 12, so that the lens mounting part 10 moves toward a direction close to the viewfinder eyepiece of the VR apparatus; when the guide adjustment part 20 takes the axis thereof as the center line and rotates around the axis thereof in a reverse direction, a top wall surface of the at least one first guide groove 22 abuts against the at least one first guide protrusion 12, so that the lens mounting part 10 moves in a direction away from the viewfinder eyepiece of the VR apparatus, and thereby changing the diopters.

Those who skilled in the art may know that the at least one first guide groove 22 may also be defined on the outer surface of the lens mounting part 10, and the at least one first guide protrusion 12 may be disposed on the inner surface of the accommodating cavity 21, which is defined herein.

As an improvement, referring to FIGS. 8 and 10, a plurality of first guide protrusions 12 are disposed on the outer surface of the lens mounting part 10, the plurality of the first guide protrusions 12 are annularly disposed at equal intervals on the outer surface of the lens mounting part 10, a plurality of first guide grooves 22 are defined on the inner wall of the accommodating cavity 21, and the plurality of the first guide protrusions 12 are disposed in one-to-one correspondence with the plurality of the first guide grooves 22, so that an overall structure is more stable when the guide movement part 20 rotates and the lens mounting part 10 moves.

In the embodiments of the present disclosure, three first guide protrusions 12 are annularly disposed at equal intervals on the outer surface of the lens mounting part 10, three first guide grooves 22 are annularly defined at equal intervals on the inner surface of the accommodating cavity 21. Those who skilled in the art may know that a number of the at least one first guide protrusion 12 and a number of the at least one first guide groove 22 may be determined according to actual needs, the number of the at least one first guide protrusion 12 and the number of the at least one first guide groove 22 may strictly correspond to each other, for example, one first guide protrusion 12 corresponds to one first guide groove 22, or, three first guide protrusions 12 correspond to one first guide groove 22, and the three first guide protrusions 12 are in clearance fit with the one first guide groove 22, which is not limited herein.

Referring to FIG. 5, both the lens mounting part 10 and the guide adjustment part 20 are cylindrical structures, the guide adjustment part 20 coaxially covers on a periphery of the lens mounting part 10, in a normal direction of the first direction D1, the guide adjustment part 20 at least partially overlaps the lens mounting part 10, an occupied space thereof in the VR apparatus is reduced, so that the VR apparatus is lighter and thinner.

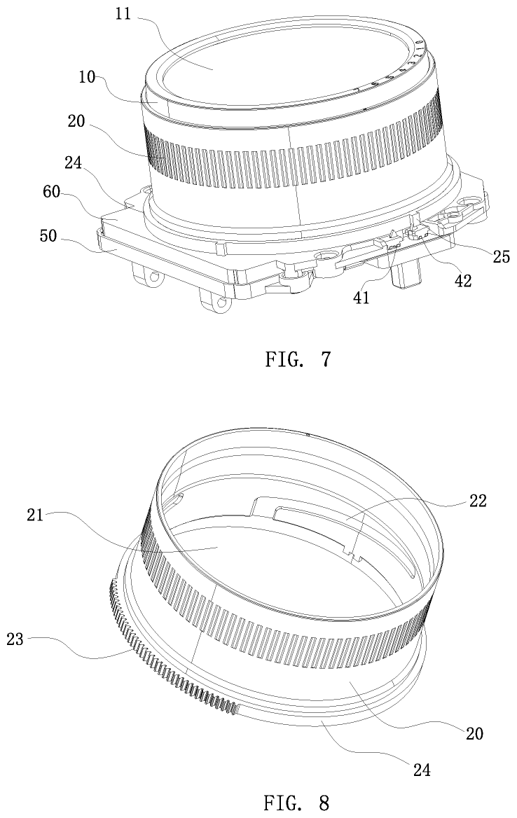

In the embodiments of the present disclosure, referring to FIG. 7, the diopter adjustment device includes a limiting part 40, the limiting part 40 is configured to limit further movement of the guide adjustment part 20 when the guide adjustment part 20 moves from a starting end of the preset path to a tail end of the preset path, thereby limiting a movement rang of the lens mounting part 10 to avoid the lens mounting part 10 from interfering with other components in the VR apparatus due to excessive movement.

In one embodiment, further referring to FIG. 7, the limiting part 20 includes at least one limiting protrusion 25, a first travel switch 41, and a second travel switch 42. The at least one limiting protrusion 25 is disposed on the guide adjustment part 20 and rotates along with the guide adjustment part 20. Both the first travel switch 41 and the second travel switch 42 are electrically connected to the driving motor 31 of the driving part 30.

When the driving motor 31 rotates in the forward direction, the guide adjustment part 20 is driven to rotate in the forward direction to further drive the at least one limiting protrusion 25 to rotate in the forward direction. The first travel switch 41 is disposed at the tail end of the preset path, when the at least one limiting protrusion 25 moves to the tail end of the preset path, the at least one limiting protrusion 25 triggers the first travel switch 41, the driving motor 31 stops working or rotates in the reverse direction, so that the at least one limiting protrusion 25 cannot cross the first travel switch 41, and after the at least one limiting protrusion 25 leaves away from the first travel switch 41, the first travel switch 41 returns to an initial state.

When the driving motor 31 rotates in the reverse direction, the guide adjustment part 20 is driven to rotate in the reverse direction to further drive the at least one limiting protrusion 25 to rotate in the reverse direction. The second travel switch 42 is disposed at the starting end of the preset path, when the at least one limiting protrusion 25 moves to the starting end of the preset path, the at least one limiting protrusion 25 triggers the second travel switch 42, the driving motor 31 stops working or rotates in the forward direction, so that the at least one limiting protrusion 25 cannot cross the second travel switch 42, and after the at least one limiting protrusion 25 leaves away from the second travel switch 42, the second travel switch 42 returns to an initial state.

In the embodiments of the present disclosure, as shown in FIGS. 1, 7, and 11, the diopter adjustment device further includes a bottom plate 50, a supporting base 60, and a pressing plate 70. The supporting base 60 is stacked on the bottom plate 50, the supporting base 60 defines a notch, and the first travel switch 41 and the second travel switch 42 are disposed on a portion of the bottom plate 50 exposed through the notch.

The bottom plate 50 includes a motor mounting plate 80, the driving motor 31 and the transmission gear set 33 are both disposed on the motor mounting plate 80, a bearing housing is disposed on the motor mounting plate 80, and the worm 32 is rotatably supported in the bearing housing.

A through groove is defined on the pressing plate, the guide adjustment part 20 is rotatably disposed on the supporting base 60, one end of the guide adjustment part 20 passes through the through groove, the pressing plate 70 is configured to limit movements of the guide adjustment part 20 in the normal direction of the first direction D1 and in the first direction D1, so that the guide adjustment part 20 may only rotate. An outer peripheral surface of the guide adjustment part 20 is sleeved with or integrally formed with a convex ring 24, the gear ring 23 and the at least one limiting protrusion 25 are both disposed on an outer peripheral surface of the convex ring 24, a preset gap is formed between the pressing plate 70 and the supporting base 60, and the convex ring 24 is clamped in the preset gap by the pressing plate 70 and the supporting base 60.

A convex cylinder 61 protrudes from the supporting base 60, at least one second guide groove 62 is defined in the convex cylinder 61, the at least one second guide groove 62 extends in the first direction D1, the lens mounting part 10 is coaxially disposed in the guide adjustment part 20, and the lens mounting part 10 is in clearance fit with the convex cylinder 61, at least one second guide protrusion 13 is disposed on a peripheral surface of the lens mounting part 10. The at least one second guide protrusion 13 is in clearance fit with the at least one second guide groove 62, and the lens mounting part 10 and the guide adjustment part 20 are connected through the at least one first guide groove 22, the at least one first guide protrusion 12, the at least one second guide groove 62, and the at least one second guide protrusion 13 to guide the lens mounting part 10 to move in the first direction D1.

Based on above, the present disclosure further provides the VR device, including the diopter adjustment device as foregoing, which is capable of automatically adjusting the diopters, is simple in structure and assembly, and further achieving mass production.

Structures, features, and effects of the present disclosure are described in detail above according to the embodiments shown in the drawings, but the above are only preferred embodiments of the present disclosure, and the present disclosure is not limited to an implementation scope shown in the drawings, and any changes made according to a concept of the present disclosure or equivalent embodiments modified to equivalent changes still fall within a protection scope of the present disclosure without departing from a spirit covered by the specification and the drawings of the present disclosure.

What is claimed is:

1. A diopter adjustment device, comprising:
a lens mounting part;
a guide adjustment part; and
a driving part;
wherein the lens mounting part is configured to mount a lens module; the guide adjustment part is connected to the lens mounting part, the guide adjustment part moves along a preset path to drive the lens mounting part to move along a first direction; and
the driving part is configured to drive the guide adjustment part to move along the preset path.

2. The diopter adjustment device according to claim 1, wherein the driving part comprises a driving motor, a worm, a transmission gear set, and a ring gear; an output shaft of the driving motor is coupled to the worm to drive the worm to rotate; the ring gear is disposed on the guide adjustment part, and the transmission gear set is respectively engaged with the worm and the gear ring.

3. The diopter adjustment device according to claim 2, wherein the transmission gear set comprises a first gear and a second gear, the first gear and the second gear are coaxially disposed, a diameter of the first gear is different from a diameter of the second gear, the first gear is engaged with the worm, and the second gear is engaged with the gear ring.

4. The diopter adjustment device according to claim 1, wherein the guide adjustment part defines an accommodating cavity, at least one first guide groove is defined on an inner surface of the accommodating cavity, a preset included angle is formed between an extending direction of the at least one first guide groove and the first direction; and
the lens mounting part is at least partially accommodated in the accommodating cavity, at least one first guide protrusion is disposed on an outer surface of the lens mounting part, and the least one first guide protrusion is in clearance fit with the first guide groove.

5. The diopter adjustment device according to claim 4, wherein a plurality of first guide protrusions are disposed on the outer surface of the lens mounting part, a plurality of first guide grooves are defined on the inner wall of the accommodating cavity, and the plurality of the first guide protrusions are disposed in one-to-one correspondence with the plurality of the first guide grooves.

6. The diopter adjustment device according to claim 4, wherein the at least one first guide groove spirally extends.

7. The diopter adjustment device according to claim 1, wherein both the lens mounting part and the guide adjustment part are cylindrical structures, the guide adjustment part coaxially covers on a periphery of the lens mounting part.

8. The diopter adjustment device according to claim 1, wherein the diopter adjustment device comprises a limiting part, the limiting part is configured to limit further movement of the guide adjustment part when the guide adjustment part moves from a starting end of the preset path to a tail end of the preset path.

9. The diopter adjustment device according to claim 8, wherein the limiting part comprises at least one limiting protrusion, a first travel switch, and a second travel switch;
the at least one limiting protrusion is disposed on the guide adjustment part; and
both the first travel switch and the second travel switch are electrically connected to the driving part; the first travel switch is disposed at the tail end of the preset path, when the at least one limiting protrusion moves to the tail end of the preset path, the at least one limiting protrusion triggers the first travel switch; the second travel switch is disposed at the starting end of the preset path, when the at least one limiting protrusion moves to the starting end of the preset path, the at least one limiting protrusion triggers the second travel switch.

10. A virtual reality (VR) apparatus, comprising:
the diopter adjustment device according to claim 1.
